(19) United States
(12) Patent Application Publication
(10) Pub. No.: US 2016/0139802 A1
(43) Pub. Date: May 19, 2016

(54) ELECTRONIC DEVICE AND METHOD FOR PROCESSING HANDWRITTEN DOCUMENT DATA

(71) Applicant: KABUSHIKI KAISHA TOSHIBA, Tokyo (JP)

(72) Inventors: Takehiro Ogawa, Hamura Tokyo (JP); Rumiko Hashiba, Kunitachi Tokyo (JP)

(21) Appl. No.: 15/005,898

(22) Filed: Jan. 25, 2016

Related U.S. Application Data
(63) Continuation of application No. PCT/JP2013/082975, filed on Dec. 9, 2013.

(51) Int. Cl. G06F 3/0488; G06F 17/24

(52) U.S. Cl. CPC G06F 3/04883; G06F 17/242

(57) ABSTRACT

According to one embodiment, an electronic device receives a first stroke made on a first position of a screen, displays the first stroke at the first position on the screen, determines a first handwriting candidate in accordance with the first stroke, and displays the first handwriting candidate on the screen. The electronic device receives a second stroke made on a second position of the screen, displays the second stroke at the second position on the screen, and determines a distance between the first position and the second position. The electronic device determines, in accordance with the distance, either a second handwriting candidate conforming to both the first stroke and the second stroke, or a third handwriting candidate conforming to the second stroke, not the first stroke.

### CROSS-REFERENCE TO RELATED APPLICATIONS

This application is a Continuation Application of PCT Application No. PCT/JP2013/082975, filed Dec. 9, 2013, the entire contents of which are incorporated herein by reference.

### FIELD

Embodiments described herein relate generally to a technique for processing handwritten document data.

### BACKGROUND

In recent years, various types of electronic devices such as tablet computers, PDAs and smartphones have been developed. Most of these devices comprise a touchscreen display allowing the user to easily input data.

In addition, electronic devices capable of processing handwritten character strings have recently been developed.

However, conventional handwriting processing does not support a technique for smoothly inputting data by handwriting.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing the external appearance of an electronic device according to an embodiment.

FIG. 2 exemplarily shows the cooperative operation between the electronic device of FIG. 1 and an external device.

FIG. 3 shows an example of a document handwritten on a touchscreen display of the electronic device of FIG. 1.

FIG. 4 is exemplarily shown for explaining time-series data which is generated by the electronic device of FIG. 1 and corresponds to the handwritten document of FIG. 3.

FIG. 5 is an exemplary block diagram showing the system configuration of the electronic device of FIG. 1.

FIG. 6 is an exemplary block diagram showing the functional structure of a handwritten note application program executed by the electronic device of FIG. 1.

FIG. 7 is exemplarily shown for explaining examples of stroke candidates displayed by the electronic device of FIG. 1.

FIG. 8 is exemplarily shown for explaining examples of stroke candidates which are newly displayed by the electronic device of FIG. 1 when strokes are further input in the state of FIG. 7.

FIG. 9 is exemplarily shown for explaining an operation for completing a handwritten stroke by the electronic device of FIG. 1.

FIG. 10 is exemplarily shown for explaining an operation which is performed by the electronic device of FIG. 1 when a confirm button (cancel button) is tapped.

FIG. 11 is exemplarily shown for explaining an operation which is performed by the electronic device of FIG. 1 when the distance between the strokes which have been already input and the new stroke is great.

FIG. 12 is exemplarily shown for explaining an operation which is performed by the electronic device of FIG. 1 when the distance between the strokes which have been already input and the new stroke is small.

FIG. 13 is exemplarily shown for explaining an operation for calculating the lateral distance between two strokes which have been input.

FIG. 14 is exemplarily shown for explaining an operation for calculating the longitudinal distance between two strokes which have been input.

FIG. 15 is exemplarily shown for explaining another operation for calculating the lateral distance between two strokes which have been input.

FIG. 16 is an exemplary flowchart shown for explaining the procedure of a handwriting-complete process which is performed by the electronic device of FIG. 1.

### DETAILED DESCRIPTION

Various embodiments will be described hereinafter with reference to the accompanying drawings.

In general, according to one embodiment, an electronic device comprises a display and a hardware processor. The display is configured to detect a stroke made on a screen of the display and display the stroke on the screen. The hardware processor receives a first stroke made on a first position of the screen, displays the first stroke at the first position on the screen, determines a first handwriting candidate in accordance with the first stroke, and displays the first handwriting candidate on the screen. The hardware processor receives a second stroke made on a second position of the screen, displays the second stroke at the second position on the screen, and determines a distance between the first position and the second position. The hardware processor determines, in accordance with the distance, either a second handwriting candidate conforming to both the first stroke and the second stroke, or a third handwriting candidate conforming to the second stroke, not the first stroke, and displays either the second handwriting candidate or the third handwriting candidate on the screen.

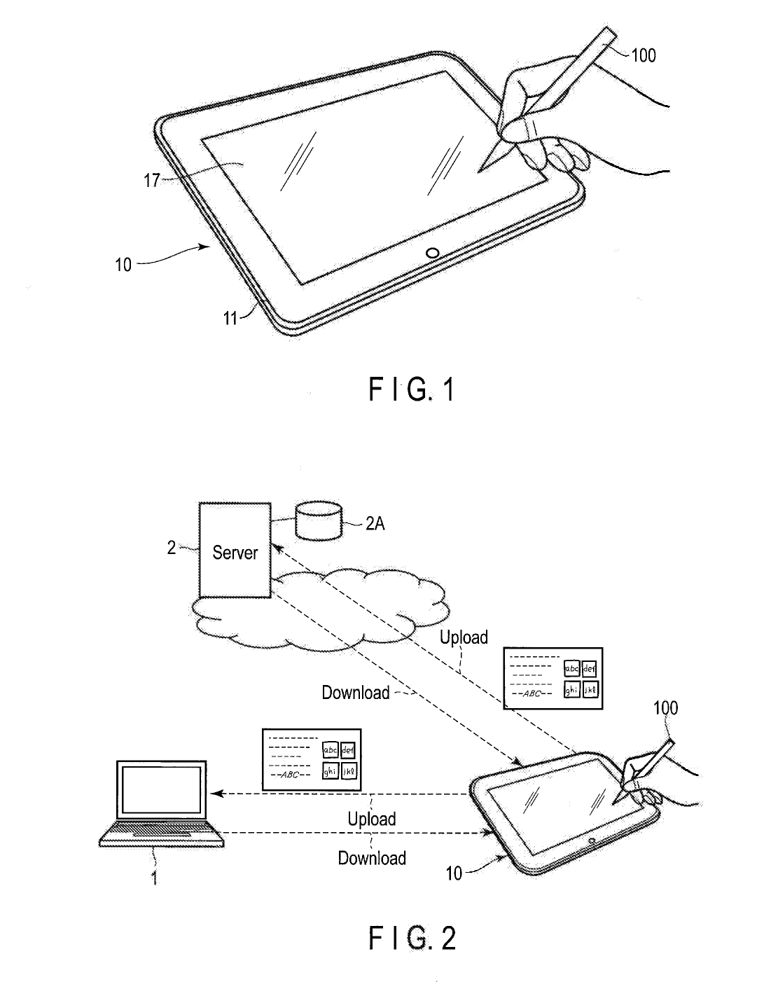

FIG. 1 is a perspective view showing the external appearance of an electronic device according to an embodiment. The electronic device is, for example, a pen-based portable electronic device which enables the user to input data by handwriting with a pen (stylus) or a finger. The electronic device may be realized as, for example, a tablet computer, a notebook computer, a smartphone or a PDA. In the explanation below, this specification assumes that the electronic device is realized as a tablet computer 10. The tablet computer 10 is a portable electronic device which is also called a tablet or a slate computer. As shown in FIG. 1, the tablet computer 10 comprises a main body 11 and a touchscreen display 17. The main body 11 comprises a thin, box-shaped housing. The touchscreen display 17 is installed so as to overlap the upper surface of the main body 11.

A flat-panel display and a sensor are incorporated into the touchscreen display 17. The sensor is configured to detect the contact position of a pen or a finger on the screen of the flat-panel display. The flat-panel display may be, for example, a liquid crystal display (LCD). For the sensor, for example, a capacitive touchpanel or an electromagnetic induction digitizer may be used. In the explanation below, this specification assumes that both of the two sensors, which are a digitizer and a touchpanel, are incorporated into the touchscreen display 17.

For example, the digitizer is arranged under the screen of the flat-panel display, while the touchpanel is arranged on the screen. The touchscreen display 17 is capable of detecting a touch operation made on the screen with a finger as well as a touch operation made on the screen with a pen 100. The pen 100 may be, for example, a digitizer pen (a type of pen using electromagnetic induction). The user can perform a handwriting input operation on the touchscreen display 17, using an external object (the pen 100 or a finger). During the handwriting input operation, the locus of movement of the external object (the pen 100 or the finger) on the screen is drawn in real time. In other words, the locus of each stroke input by handwriting is drawn in real time. In this manner, the locus of each stroke is displayed on the screen. The locus of movement of the external object in the period of contact of the external object on the screen is equivalent to one stroke. The assembly of many strokes corresponding to handwritten characters, figures, etc., constitutes a handwritten document. In other words, the assembly of many loci (strokes) constitutes a handwritten document.

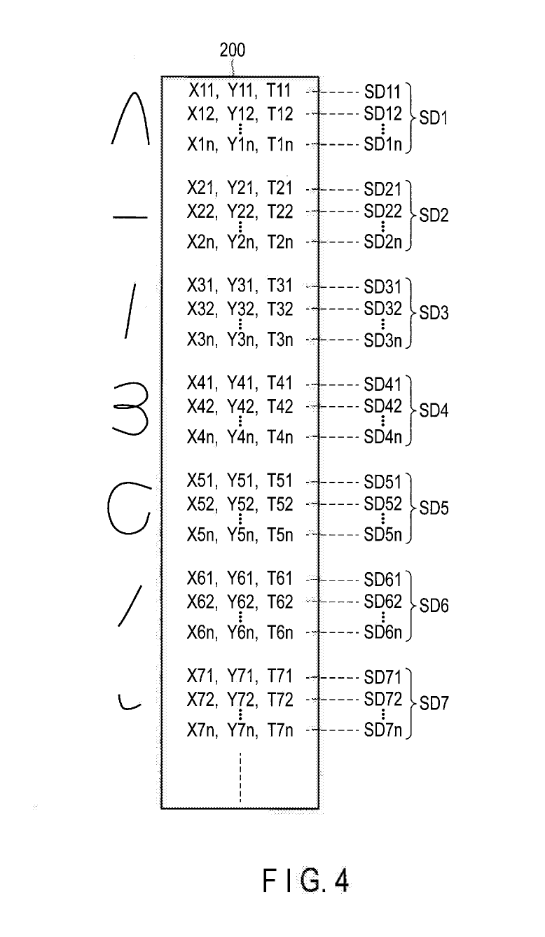

In the present embodiment, the handwritten document is not stored as image data. Instead, the handwritten document is stored in a storage medium as time-series data indicating a series of coordinates of the locus of each stroke and the order relationships of strokes. The detail of time-series data is explained later with reference to FIG. 4. Briefly speaking, time-series data indicates the order in which a plurality of strokes were handwritten, and includes a plurality of stroke data items corresponding to a plurality of strokes, respectively. In other words, time-series data means the assembly of time-series stroke data items corresponding to a plurality of strokes, respectively. Each stroke data item corresponds to a stroke and includes a series of coordinate data items (time-series coordinates) each corresponding to a point on the locus of the stroke. The order in which the stroke data items are arranged is equivalent to the order in which the strokes were made, in other words, the writing order.

The tablet computer 10 is capable of reading an arbitrary existing time-series data item (handwritten document data item) from the storage medium and displaying a handwritten document corresponding to the time-series data item on the screen. In other words, the tablet computer 10 is capable of displaying the loci respectively corresponding to a plurality of strokes indicated by the time-series data item on the screen. The tablet computer 10 further has an edit function. For example, the edit function allows the user to delete or move an arbitrary stroke, an arbitrary handwritten character, etc., in the handwritten document displayed in real time in accordance with a user's edit operation using an eraser tool, a range specification tool or any of various other tools. The edit function further includes a function for undoing the history of some handwriting operations.

The tablet computer 10 further has a handwriting-complete function (in other words, a function for suggesting a stroke). The handwriting-complete function is a function to assist the user perform handwriting input such that a large number of character strings can be easily input.

FIG. 2 shows an example of the cooperative operation between the tablet computer 10 and an external device. The tablet computer 10 is capable of cooperating with a personal computer 1 and a cloud. The tablet computer 10 comprises a wireless communication device such as a wireless LAN and is capable of wirelessly communicating with the personal computer 1. The tablet computer 10 is also capable of communicating with a server 2 on the Internet. The server 2 may be a server which executes an online storage service and other various cloud computing services.

The personal computer 1 comprises a storage device such as a hard disk drive (HDD). The tablet computer 10 is capable of transmitting time-series data (a handwritten document) to the personal computer 1 via a network and storing the data on the HDD of the personal computer 1 (this process may be referred to as uploading).

In this manner, even when the capacity of the storage of the tablet computer 10 is small, the tablet computer 10 is capable of dealing with a large number of time-series data items (handwritten documents) or a large volume of time-series data items (handwritten documents).

Moreover, the tablet computer 10 is capable of reading at least one arbitrary handwritten document stored on the HDD of the personal computer 1 (this process may be referred to as downloading). The tablet computer 10 is capable of displaying the locus of each of the strokes indicated by the read document on the screen of the touchscreen display 17 of the tablet computer 10. In this case, a list of thumbnails obtained by scaling down the pages of handwritten documents, respectively, may be displayed on the screen of the touchscreen display 17, or one page selected from the thumbnails may be displayed on the screen of the touchscreen display 17 in the normal size.

As described above, the other party with which the tablet computer 10 communicates need not be the personal computer 1 and may be the server 2 in the cloud which provides a storage service, etc. The tablet computer 10 is capable of transmitting a handwritten document to the server 2 via a network and storing the document in a storage device 2A of the server 2 (this process may be referred to as uploading). The tablet computer 10 is also capable of reading an arbitrary handwritten document stored in the storage device 2A of the server 2 (this process may be referred to as downloading). The tablet computer 10 is capable of displaying the locus of each of the strokes indicated by the read document on the screen of the touchscreen display 17 of the tablet computer 10.

In the present embodiment, the storage medium in which a handwritten document is stored may be any one of the storage device of the tablet computer 10, the storage device of the personal computer 1 and the storage device of the server 2.

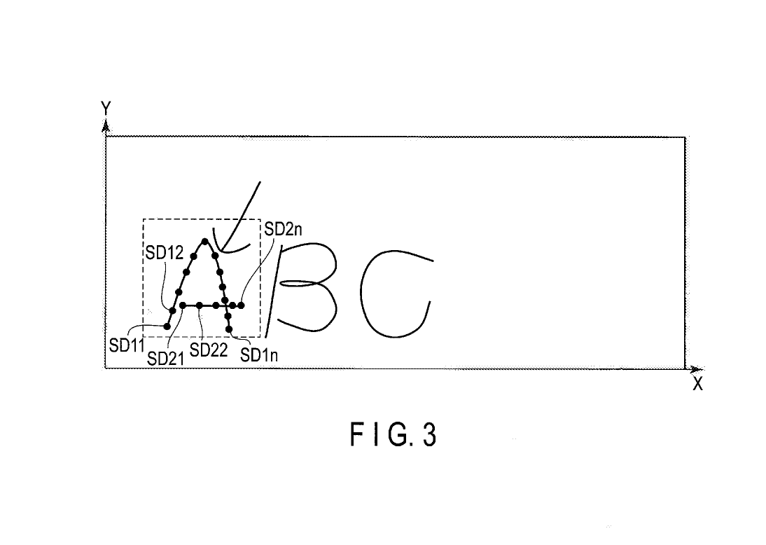

Now, this specification explains the relationship between strokes (characters, marks, figures [diagrams], tables, etc.) made by the user and a handwritten document, referring to FIG. 3 and FIG. 4. FIG. 3 shows an example of a character string handwritten on the touchscreen display 17 with the pen 100, etc.

In many cases, a character or figure is handwritten in a document, and another character or figure is handwritten on the character or figure which has been already written. In FIG. 3, the character string “ABC” is handwritten in the order of “A”, “B” and “C”, and subsequently, an arrow is handwritten in vicinity to the handwritten character “A”.

The handwritten character “A” is shown by two strokes (the locus in the form of “ [symbol] ” and the locus in the form of “-”) made with the pen 100, etc.; in short, by two loci. For example, the first locus of the pen 100 in the form of “ [symbol] ” is sampled in real time at equal time intervals. Through this process, the time-series coordinates (SD11, SD12, . . . , SD1n) of the stroke in the form of “A” are obtained. The subsequent locus of the pen 100 in the form of “-” is also sampled in real time at equal time intervals. Through this process, the time-series coordinates (SD21, SD22, . . . , SD2n) of the stroke in the form of “-” are obtained.

The handwritten character “B” is shown by two strokes made with the pen 100, etc.; in short, by two loci. The handwritten character “C” is shown by one stroke made with the pen 100, etc.; in short, by one locus. The handwritten arrow is shown by two strokes made with the pen 100, etc.; in short, by two loci.

FIG. 4 shows time-series data 200 corresponding to the handwritten character string shown in FIG. 3. The time-series data 200 includes a plurality of stroke data items SD1, SD2, . . . , SD7. In the time-series data 200, stroke data items SD1, SD2, . . . , SD7 are arranged in the writing order; that is, the chronological order in which the strokes were made.

In the time-series data 200, the first two stroke data items (SD1 and SD2) indicate the two strokes of the handwritten character “A”. The third and fourth stroke data items (SD3 and SD4) indicate the two strokes constituting the handwritten character “B”. The fifth stroke data item (SD5) indicates the stroke constituting the handwritten character “C”. The sixth and seventh stroke data items (SD6 and SD7) indicate the two strokes constituting the handwritten arrow.

Each stroke data item includes a series of coordinate data items (time-series coordinates) corresponding to one stroke. In other words, each stroke data item includes a plurality of coordinates corresponding to a plurality of points on the locus of one stroke, respectively. In each stroke data item, a plurality of coordinates are arranged in the chronological order in which the stroke was made. For example, with regard to the handwritten character “A”, stroke data item SD1 includes a series of coordinate data items (time-series coordinates) each corresponding to a point on the locus of the stroke in the form of “ [symbol] ” of the handwritten character “A”. In other words, stroke data item SD1 includes n coordinate data items (SD11, SD12, . . . , SD1n). Stroke data item SD2 includes a series of coordinate data items each corresponding to a point on the locus of the stroke in the form of “-” of the handwritten character “A”. In other words, stroke data item SD2 includes n coordinate data items (SD21, SD22, . . . , SD2n). The number of coordinate data items may differ depending on the stroke data item. Thus, the locus of the pen 100 is sampled in real time at equal time intervals. Therefore, the longer the stroke is, or the more slowly the stroke is made, the more coordinate data items are obtained.

Each coordinate data item indicates the x- and y-coordinates corresponding to a point on the corresponding locus. For example, coordinate data item SD11 indicates the x-coordinate (X11) and the y-coordinate (Y11) of the start point of the stroke in the form of “ [symbol] ”. SD1n indicates the x-coordinate (X1n) and the y-coordinate (Y1n) of the end point of the stroke in the form of “ [symbol] ”.

Each coordinate data item may further include timestamp data T corresponding to the time when the point corresponding to the coordinates was handwritten. The time when the point was handwritten may be an absolute time (for example, year/month/day/hour/minute/second) or a relative time based on a time point. For example, the absolute time (for example, year/month/day/hour/minute/second) when the user started writing a stroke may be added as timestamp data to the corresponding stroke data item. The relative time indicating the difference from the absolute time may be added as timestamp data T to each coordinate data item of the stroke data item.

It is possible to further accurately show the temporal relationships between strokes by using time-series data in which timestamp data T is added to each coordinate data item.

Moreover, data Z indicating the writing pressure may be added to each coordinate data item.

The time-series data 200 having the structure explained in FIG. 4 enables the temporal relationships between strokes as well as the locus of each stroke to be shown. The use of the time-series data 200 allows the handwritten character “A” and the apical end portion of the handwritten arrow to be dealt with as a character and a figure different from each other even when the apical end portion of the handwritten arrow overlaps or is close to the handwritten character “A” as shown in FIG. 3. Timestamp data T may be used as option data. A plurality of stroke data items each of which does not include timestamp data T may be used as the above time-series data.

In the present embodiment, as described above, a handwritten document is not stored as an image or the result of character recognition. Instead, a handwritten document is stored as the assembly of time-series stroke data items. Therefore, handwritten characters can be dealt with without relying on the language of the characters. Thus, the structure of the time-series data 200 of the present embodiment may be used in common with various countries using different languages in the world.

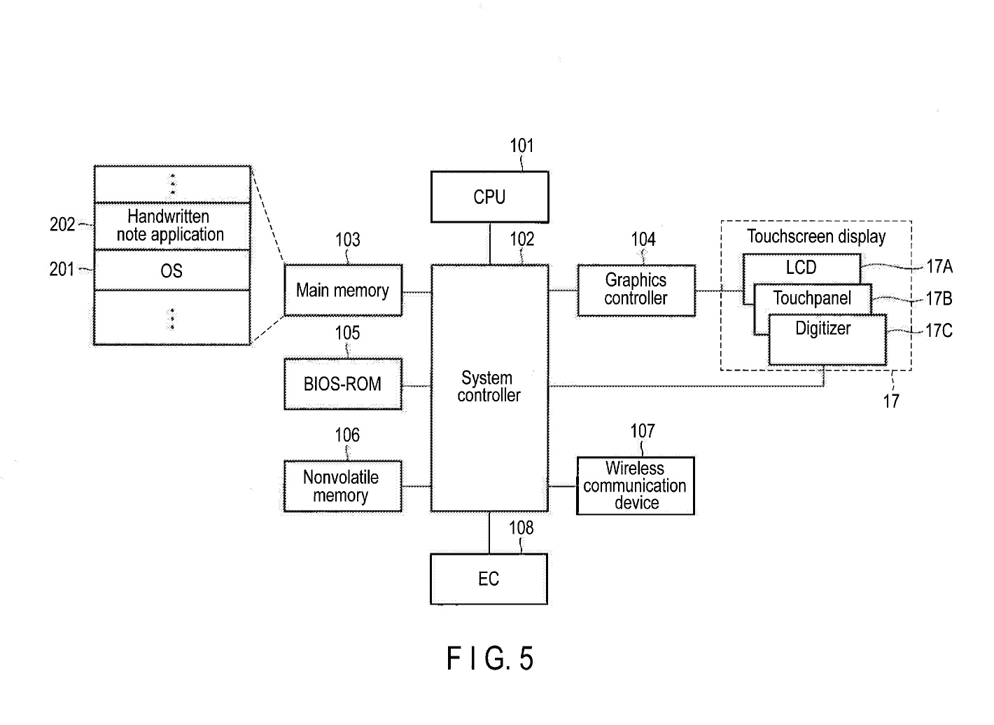

FIG. 5 shows the system configuration of the tablet computer 10.

The tablet computer 10 comprises, as shown in FIG. 5, a CPU 101, a system controller 102, a main memory 103, a graphics controller 104, a BIOS-ROM 105, a nonvolatile memory 106, a wireless communication device 107, an embedded controller (EC) 108, etc.

The CPU 101 is a processor (hardware processor) configured to control the operations of various modules of the tablet computer 10. The CPU 101 executes various computer programs loaded from the nonvolatile memory 106 which is a storage device to the main memory 103. The programs include an operating system (OS) 201 and various application programs. The application programs include a handwritten note application program 202. For example, the handwritten note application program 202 has a function for creating and displaying the handwritten document described above, a function for editing a handwritten document and a handwriting-complete function.

The CPU 101 executes a Basic Input/Output System (BIOS) stored in the BIOS-ROM 105. The BIOS is a program for hardware control.

The system controller 102 is a device which connects a local bus of the CPU 101 and various components. The system controller 102 comprises a built-in memory controller configured to control the access to the main memory 103. The system controller 102 has a function for communicating with the graphics controller 104 through a serial bus conforming to the PCI EXPRESS standard, etc.

The graphics controller 104 is a display controller configured to control an LCD 17A used as a display monitor of the tablet computer 10. A display signal generated by the graphics controller 104 is transmitted to the LCD 17A. The LCD 17A displays a screen image on the basis of the display signal. A touchpanel 17B and a digitizer 17C are provided on the LCD 17A. The touchpanel 17B is a capacitive pointing device for inputting data on the screen of the LCD 17A. The touchpanel 17B detects the contact position of a finger on the screen, the movement of the contact position, etc. The digitizer 17C is an electromagnetic induction type of pointing device for inputting data via the screen of the LCD 17A. The digitizer 17C detects the contact position of the pen 100 on the screen, the movement of the contact position, etc.

The wireless communication device 107 is a device configured to perform wireless communication using, for example, a wireless LAN or 3G mobile communication. The EC 108 is a single-chip microcomputer including an embedded controller for power management. The EC 108 has a function for switching the tablet computer 10 on or off in response to the operation of the power button by the user.

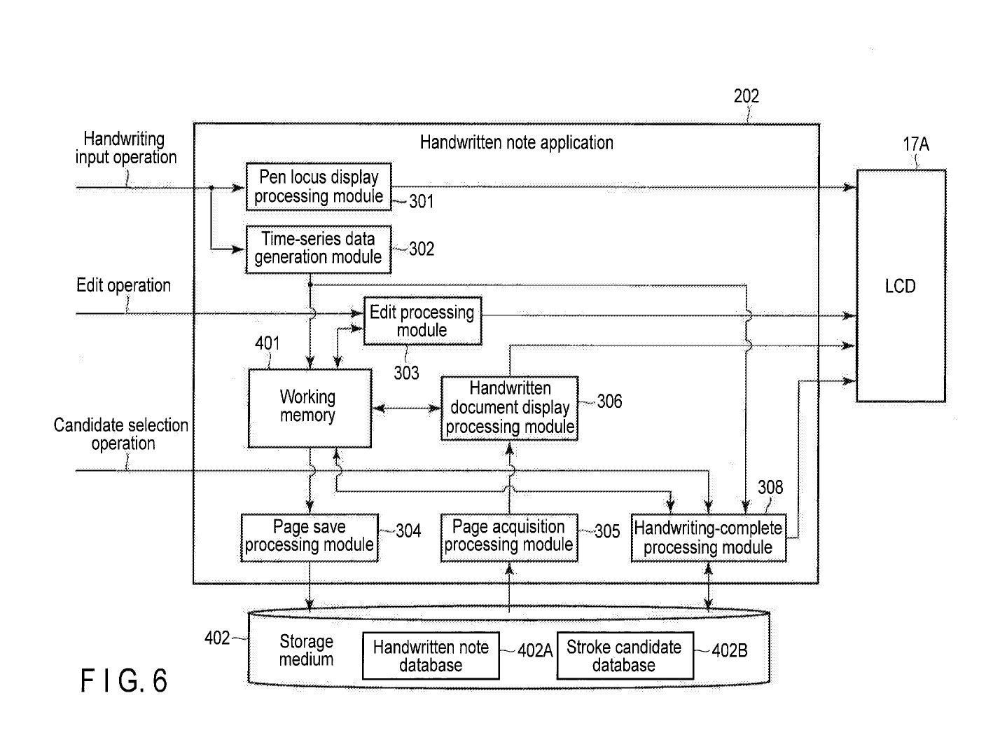

Now, this specification explains the functional structure of the handwritten note application program 202 with reference to FIG. 6.

The handwritten note application program 202 comprises, for example, a pen locus display processing module 301, a time-series data generation module 302, an edit processing module 303, a page save processing module 304, a page acquisition processing module 305, a handwritten document display processing module 306 and a handwriting-complete processing module 308.

The handwritten note application program 202 creates, displays and edits a handwritten document (handwritten data) by using stroke data which is input with the touchscreen display 17. The touchscreen display 17 is configured to detect the generation of an event such as the event “touch”, “move” (“slide”) or “release”. The event “touch” is an event indicating that an external object comes in contact with the screen. The event “move” (“slide”) is an event indicating that the contact position is moved while the external object is in contact with the screen. The event “release” is an event indicating that the external object is separated from the screen.

The pen locus display processing module 301 and the time-series data generation module 302 receive the event “touch” or “move” (“slide”) generated by the touchscreen display 17 and detect a handwriting input operation by the reception. The event “touch” includes the coordinates of the contact position. The event “move” (“slide”) includes the coordinates of the contact position of the destination of the move. Thus, the pen locus display processing module 301 and the time-series data generation module 302 are capable of receiving a series of coordinates corresponding to the locus of the movement of the contact position from the touchscreen display 17.

The pen locus display processing module 301 functions as a display processing module configured to display the stroke input by handwriting on the screen of the touchscreen display 17. The pen locus display processing module 301 receives a series of coordinates from the touchscreen display 17. On the basis of the received coordinates, the pen locus display processing module 301 displays a plurality of strokes input by handwriting with the pen 100, etc., on the screen of the LCD 17A of the touchscreen display 17.

The time-series data generation module 302 receives the aforementioned coordinates output from the touchscreen display 17. On the basis of the received coordinates, the time-series data generation module 302 generates a plurality of stroke data items (time-series data) corresponding to the plurality of strokes described above. These stroke data items may be temporarily stored in a working memory 401. In other words, the coordinates corresponding to each point of each stroke, and timestamp data of each stroke may be temporarily stored in the working memory 401.

The page save processing module 304 stores handwritten document data including a plurality of stroke data items corresponding to a plurality of strokes in a handwritten note database 402A of a storage medium 402. As stated above, the storage medium 402 may be any one of the storage device of the tablet computer 10, the storage device of the personal computer 1 and the storage device of the server 2.

The page acquisition processing module 305 reads arbitrary handwritten document data from the storage medium 402. The read document data is transmitted to the handwritten document display processing module 306. The handwritten document display processing module 306 analyzes the handwritten document data. On the basis of the result of analysis, the handwritten document display processing module 306 displays the loci of a plurality of strokes indicated by a plurality of stroke data items of the handwritten document data on the screen as a handwritten page.

The edit processing module 303 performs a process for editing the handwritten document (handwritten page) displayed in progress. The edit processing module 303 performs an edit process for, for example, deleting or moving at least one of a plurality of strokes which are currently displayed in accordance with an edit operation performed by the user on the touchscreen display 17. The edit processing module 303 updates the handwritten document displayed in progress to reflect the result of the edit process on the handwritten document.

The user can delete an arbitrary one of a plurality of strokes displayed in progress, using the eraser tool, etc. The user can specify, as the range, an arbitrary portion of the handwritten page displayed in progress, using the range specification tool for surrounding an arbitrary portion of the screen with a circle or a rectangle.

The handwriting-complete processing module 308 is a processing module configured to perform the above handwriting-complete function. In the handwriting-complete function, the handwriting-complete processing module 308 obtains one or more stroke strings (one or more handwriting candidates) corresponding to the stroke input by handwriting from the assembly of strokes (in other words, handwritten document data) input in the past. The handwriting-complete processing module 308 performs a process for displaying the obtained stroke string or stroke strings on the screen as candidates for strokes which it is permissible to input (in other words, as stroke candidates).

In other words, the handwriting-complete processing module 308 predicts the stroke string (handwritten character string) likely to be handwritten by the user on the basis of the input stroke and handwritten document data. The handwriting-complete processing module 308 shows some stroke strings obtained by the prediction as stroke candidates (handwriting candidates).

For example, when the stroke (or the handwritten character string) “a” is input by handwriting, the handwritten word “add” or “access” may be shown to the user as a candidate (handwriting candidate). When the user selects the handwritten word “access”, the handwritten word “access” is confirmed as an input handwritten character string. Thus, the user can easily input the stroke string of the handwritten word “access”.

The language of the handwritten character strings stored in handwritten document data is not limited. Examples of available languages include English, Japanese, Chinese and various other languages. With regard to English character strings, a stroke string (handwritten character string) may be one corresponding to block letters, or one corresponding to cursive letters. In some cases, a word handwritten in cursive letters is composed of a single stroke. Thus, a stroke string obtained from handwritten document data in a handwriting-complete process does not necessarily include a plurality of strokes and may be composed of only a single stroke.

Examples of a stroke string corresponding to an input stroke include a plurality of strokes including a stroke similar to the input stroke, and a single stroke including a stroke portion similar to the input stroke. For example, a stroke string in which the head stroke (or the head stroke portion) is similar to the input stroke is obtained from handwritten document data.

To easily obtain a stroke string corresponding to the input stroke from handwritten document data, the handwriting-complete processing module 308 may create a stroke candidate database 402B on the basis of the assembly of strokes (handwritten document data) stored in the handwritten note database 402A.

For example, stroke strings (groups of stroke data items) and the results of character recognition (character strings) corresponding to the groups of stroke data items may be stored in the stroke candidate database 402B in the unit of a character string having a meaning, such as a word.

In this case, the handwriting-complete processing module 308 may recognize the stroke input by the user as a character. The handwriting-complete processing module 308 refers to the stroke candidate database 402B and discovers a character string whose prefix agrees with the result of character recognition (the character string) of the input stroke. The handwriting-complete processing module 308 obtains a stroke string (a group of stroke data items) corresponding to the discovered character string from the stroke candidate database 402B as a stroke string (handwriting candidate) corresponding to the input stroke.

Alternatively, for example, stroke strings (groups of stroke data items) and the feature amount of each of the strokes corresponding to the groups of stroke data items may be stored in the stroke candidate database 402B in the unit of a character string having a meaning, such as a word. For the feature amount of a stroke, an arbitrary feature which can indicate the handwriting feature of the stroke may be used. For example, for the feature amount, the data of feature amount indicating the form of the stroke, the writing direction of the stroke or the inclination of the stroke may be used. In this case, the handwriting-complete processing module 308 may obtain a stroke string having a feature amount similar to that of the input stroke from the stroke candidate database 402B.

Alternatively, for example, stroke strings (groups of stroke data items), the results of character recognition (character strings) corresponding to the groups of stroke data items, and the feature amount of each of the strokes corresponding to the groups of stroke data items may be stored in the stroke candidate database 402B in the unit of a character string having a meaning, such as a word.

The handwriting-complete processing module 308 predicts the stroke string likely to be input by the user on the basis of the input stroke and the stroke candidate database 402B. In this prediction process, the handwriting-complete processing module 308 obtains some stroke strings (handwritten character strings, etc.) corresponding to the input stroke from the stroke candidate database 402B. The handwriting-complete processing module 308 performs a process for displaying these stroke strings on the screen as the handwriting candidates for the handwritten character string likely to be input (in other words, as the stroke candidates).

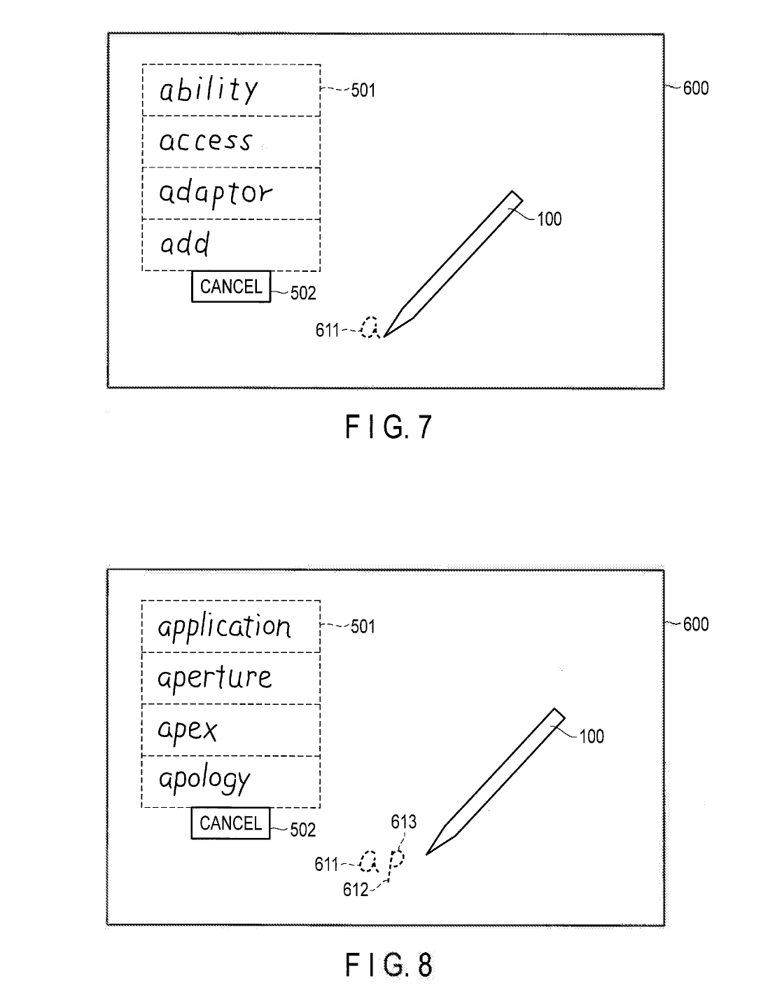

FIG. 7 shows examples of stroke candidates corresponding to the input stroke.

Here, it is assumed that stroke 611 corresponding to the handwritten character “a” is input by a handwriting input operation on an edit screen 600. The edit screen 600 is a screen used to create and edit a handwritten document (handwritten page).

When stroke 611 is input by handwriting, the handwriting-complete processing module 308 obtains some stroke strings (stroke candidates) corresponding to the input stroke 611 (here, the handwritten character “a”) from the stroke candidate database 402B. The handwriting-complete processing module 308 displays each of the stroke strings in a list of stroke candidates 501 on the edit screen 600.

The input stroke 611 is dealt with as an unconfirmed stroke (or a temporary stroke). An unconfirmed stroke indicates a stroke which has not been reflected in a handwritten page. An unconfirmed stroke is the stroke to be completed. A stroke candidate which is predicted on the basis of the unconfirmed stroke is shown to the user. The input stroke 611 may be displayed in a color different from that of the pen which is currently selected, for example, red, such that stroke 611 is recognized by the user as an unconfirmed stroke (as a temporary stroke). In FIG. 7, the red stroke is shown by a broken line.

FIG. 7 assumes that four stroke strings are shown as stroke candidates in the list of stroke candidates 501. The four stroke strings include the handwritten character strings “ability”, “access”, “adaptor” and “add”.

Thus, some stroke strings starting with the handwritten character “a” are shown to the user. These stroke strings are stroke strings which were input by handwriting by the user in the past.

The handwriting-complete processing module 308 may display a cancel button 502 near the list of stroke candidates 501. The cancel button 502 functions as a confirm button for determining the input stroke (temporary stroke) as a confirmed stroke. A confirmed stroke indicates a stroke which has been reflected in a handwritten page. The stroke determined as a confirmed stroke is removed from the target to be completed.

FIG. 8 shows other examples of stroke candidates corresponding to the input strokes.

Here, it is assumed that strokes 612 and 613 corresponding to the handwritten character “p” are further input by a handwriting input operation on the edit screen 600 after the input of stroke 611 corresponding to the handwritten character “a”. In this case, the list of stroke candidates 501 is updated.

The handwriting-complete processing module 308 obtains some stroke strings (stroke candidates) corresponding to the input strokes 611, 612 and 613 (the handwritten character string “ap”) from the stroke candidate database 402B. The handwriting-complete processing module 308 displays each of the stroke strings in the list of stroke candidates 501 on the edit screen 600.

FIG. 8 assumes that four handwritten stroke strings which are the handwritten character strings “application”, “aperture”, “apex” and “apology” are shown as stroke candidates in the list of stroke candidates 501.

Thus, some handwritten character strings starting with “ap” are shown to the user.

When a stroke candidate is selected from the list of stroke candidates 501 by the user, the handwriting-complete processing module 308 displays a stroke string corresponding to the selected stroke candidate on the edit screen 600. In other words, the handwriting-complete processing module 308 completes the input handwritten strokes with a stroke string corresponding to the selected stroke candidate. In this manner, the user can easily input the desired word by merely inputting a part of the word by handwriting.

With regard to a character composed of a plurality of strokes, such as a Chinese character, the user can input the character by merely inputting a part of the plurality of strokes by handwriting.

With regard to a character string in cursive letters, the user can input a character string in cursive letters by merely inputting a part of the head of the stroke constituting the character string by handwriting.

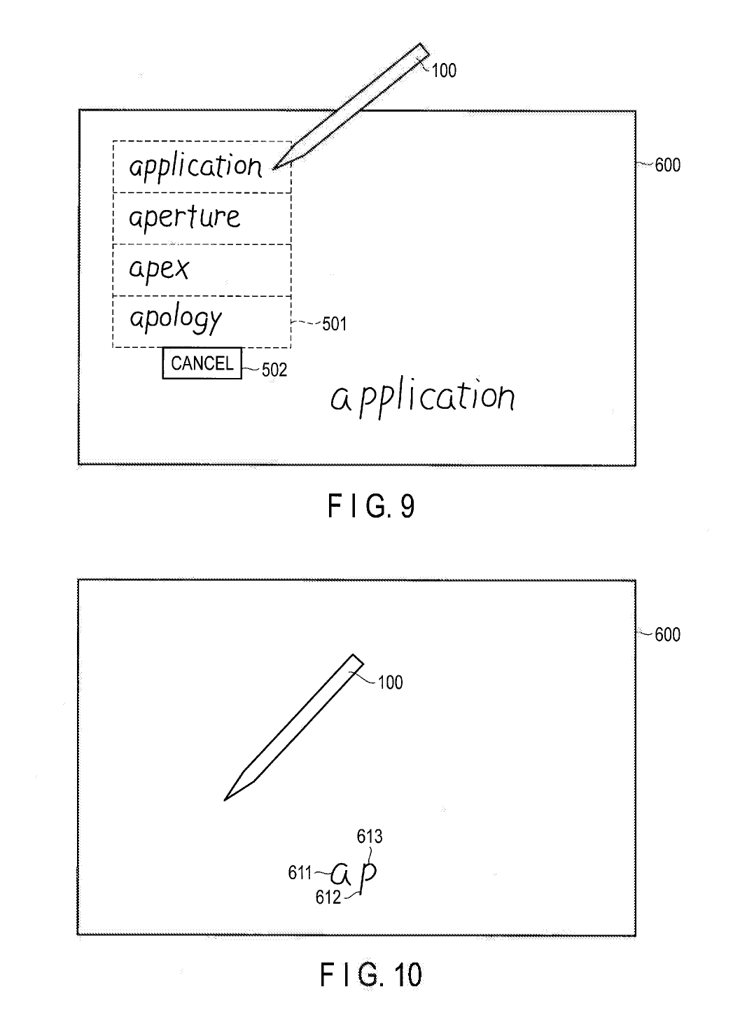

FIG. 9 shows an operation for completing the strokes which have been input by handwriting.

Here, it is assumed that the handwritten character string “application” is selected from the list of stroke candidates 501. When the handwritten character string “application” is tapped with the pen 100 or a finger, the handwriting-complete processing module 308 performs a process for displaying the handwritten character string “application” on the edit screen 600 in cooperation with the display processing module (the pen locus display processing module 301 or the handwritten document display processing module 306). In this case, the input strokes (strokes 611, 612 and 613 in FIG. 8) are completed with the handwritten character string “application”. In other words, the display processing module displays the handwritten character string “application” on the edit screen 600 in place of the input strokes (strokes 611, 612 and 613 in FIG. 8).

The handwritten character string “application” is determined as confirmed strokes and is reflected in the handwritten page which is edited in real time. The group of stroke data items of the handwritten character string “application” obtained from the stroke candidate database 402B is added to the handwritten page. When the handwritten character string “application” is a stroke string in cursive letters, a single stroke data item corresponding to the handwritten character string “application” is added to the handwritten page.

FIG. 10 shows an operation which is performed when the cancel button 502 is tapped.

When the cancel button 502 is tapped with the pen 100 or a finger, the handwriting-complete processing module 308 determines the input strokes (here, strokes 611, 612 and 613) as confirmed strokes. The handwriting-complete processing module 308 reflects the input strokes in the handwritten page which is edited in real time. In this case, three stroke data items corresponding to strokes 611, 612 and 613 are added to the handwritten page. The list of stroke candidates 501 is deleted from the edit screen.

Strokes 611, 612 and 613 may be displayed in the pen color which is currently selected, for example, black. In FIG. 10, the black strokes are shown by solid lines.

When a new stroke is further input by handwriting, the handwriting-complete processing module 308 starts a new handwriting-complete process. In this new handwriting-complete process, the handwriting-complete processing module 308 obtains, from the stroke candidate database 402B, some stroke strings corresponding to the newly input stroke. The handwriting-complete processing module 308 displays the list of stroke candidates 501 indicating the stroke strings on the edit screen 600.

The user may want to determine one or more strokes (one or more temporary strokes) which have been input as confirmed strokes while the user takes handwritten notes. For example, the user may want to determine the first target character string as confirmed strokes when the user finished inputting the first target character sting, in other words, before the user starts handwriting the next target character string. This will allow the user to use the presentation (recommendation) of a stroke candidate corresponding to the next target character string.

In this case, the user may tap the cancel button 502. However, if the user has to perform a special operation such as tapping the cancel button 502 during the handwriting input operation, the special operation could prevent smooth handwriting input.

In consideration of these factors, in the present embodiment, the handwriting-complete processing module 308 is configured to selectively perform the following two processes, which are process A and process B, in accordance with the distance between two strokes which are input successively.

Now, this specification assumes that a stroke (a first stroke) is input by handwriting, and further, a new stroke (a second stroke) is input by handwriting. First, the first stroke made on a first position of the screen is displayed at the first position on the screen, and a stroke candidate corresponding to the first stroke is displayed in response to the input of the first stroke. Then, the second stroke made on a second position of the screen is displayed at the second position on the screen. In this case, the handwriting-complete processing module 308 selectively performs two processes which are process A and process B based on the distance between the two strokes, specifically, based on the distance between the first and second strokes. Here, the distance between the strokes is equivalent to the distance between a first area in which the first stroke is displayed and a second area in which the second stroke is displayed. In other word, the distance between the strokes may be a distance between the first position and the second position.

Process A: When the distance between the first and second strokes is less than or equal to a threshold distance (a first distance), the handwriting-complete processing module 308 obtains, from the stroke candidate database 402B, some stroke strings (stroke candidates) corresponding to the combination of the first and second strokes. Each of these stroke candidates is handwriting candidate conforming to both the first stroke and the second stroke. The handwriting-complete processing module 308 performs a process for displaying these stroke strings in the list of stroke candidates 501 on the edit screen 600.

Process B: When the distance between the first and second strokes is greater than the above threshold distance, the handwriting-complete processing module 308 obtains, from the stroke candidate database 402B, some stroke strings (stroke candidates) corresponding to the second stroke regardless of the first stroke. Each of these stroke candidates is handwriting candidate conforming to the second stroke, not the first stroke. The handwriting-complete processing module 308 performs a process for displaying these stroke strings in the list of stroke candidates 501 on the edit screen 600. In this case, the first stroke is determined as a confirmed stroke and is reflected in the handwritten page.

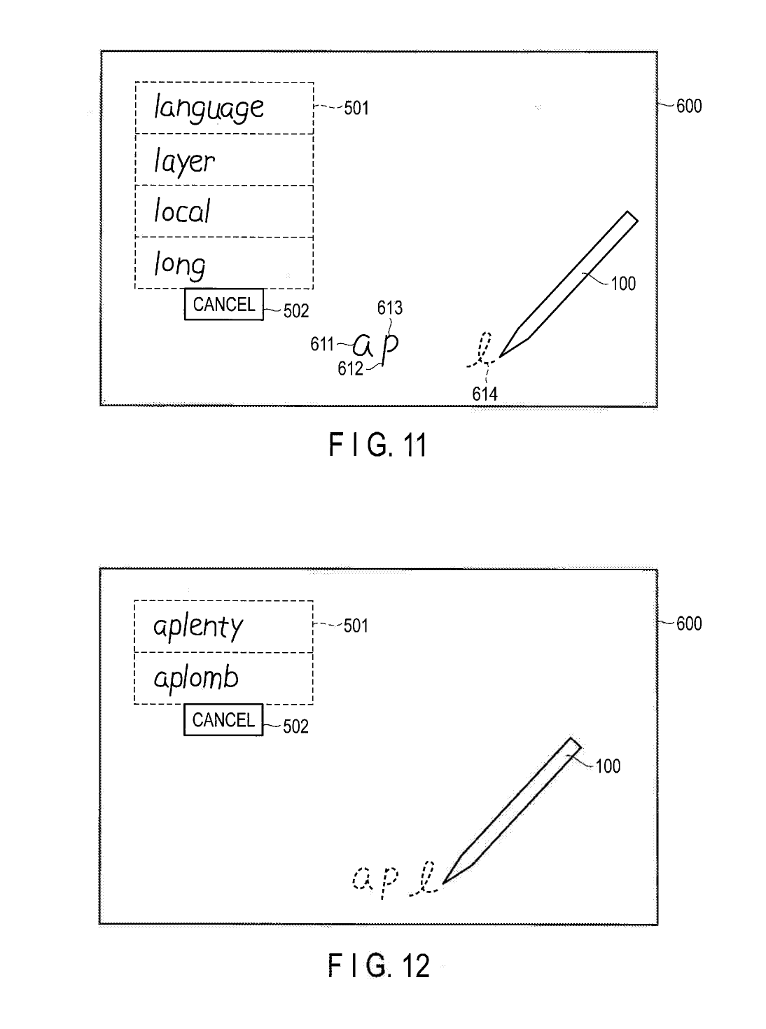

FIG. 11 shows an operation which is performed by the handwriting-complete processing module 308 when the distance between the strokes which have been already input and the new stroke is greater than a threshold distance.

Here, it is assumed that stroke 614 corresponding to the cursive handwritten character “l” is input by handwriting after strokes 611, 612 and 613 corresponding to the handwritten character string “ap” are input by handwriting. In this case, the handwriting-complete processing module 308 determines whether or not the distance between the last stroke of the stroke string corresponding to the handwritten character string “ap” and stroke 614 corresponding to the handwritten character “l” is greater than the threshold distance.

When the distance is greater than the threshold distance, the handwriting-complete processing module 308 obtains, from the stroke candidate database 402B, some stroke strings (stroke candidates) corresponding to stroke 614 regardless of strokes 611, 612 and 613. The handwriting-complete processing module 308 displays these stroke candidates in the list of stroke candidates 501 on the edit screen 600. Each of the stroke candidates is a handwriting candidate conforming to stroke 614, not strokes 611, 612 and 613.

FIG. 11 assumes that four handwritten stroke strings which are the handwritten character strings “language”, “layer”, “local” and “long” are shown as stroke candidates in the list of stroke candidates 501. Thus, some handwritten character strings starting with the handwritten character “l” are shown to the user regardless of the handwritten character string “ap”.

FIG. 12 shows an operation which is performed by the handwriting-complete processing module 308 when the distance between the strokes which have been already input and the new stroke is not greater than the threshold distance.

Here, in a manner similar to that of FIG. 11, it is assumed that stroke 614 corresponding to the handwritten character “l” is input by handwriting after strokes 611, 612 and 613 corresponding to the handwritten character string “ap” are input by handwriting. In this case, the handwriting-complete processing module 308 determines whether or not the distance between the last stroke of the stroke string corresponding to the handwritten character string “ap” and stroke 614 corresponding to the handwritten character “l” is greater than the threshold distance.

When the distance is not greater than the threshold distance, the handwriting-complete processing module 308 obtains, from the stroke candidate database 402B, some stroke strings (stroke candidates) corresponding to strokes 611, 612, 613 and 614. Each of the stroke candidates is a handwriting candidate conforming to both the strokes 611, 612 and 613 and the stroke 614.

The handwriting-complete processing module 308 displays these stroke candidates in the list of stroke candidates 501 on the edit screen 600.

FIG. 12 assumes that two handwritten stroke strings which are the handwritten character strings “aplenty” and “aplomb” are shown as stroke candidates in the list of stroke candidates 501.

Now, this specification explains a method for calculating the distance between strokes.

As stated above, when the second stroke is input by handwriting after the first stroke is input by handwriting, the distance between the first area in which the first stroke is displayed on the edit screen and the second area in which the second stroke is displayed on the edit screen is equivalent to the distance between the strokes.

For the distance between the first and second areas, the distance between the end point of the first stroke and the start point of the second stroke may be used.

The threshold distance for evaluating the distance between the first and second areas may be determined in accordance with the size (width and height) of the screen (page). The width of the screen (page) is the lateral (x-directional) dimension of the page. The height of the page is the longitudinal (y-directional) dimension of the page. For example, the distance which is substantially half the lateral (x-directional) dimension of the page may be set as the threshold distance. Processes A and B, above, are selectively performed depending on whether or not the distance between the first and second areas is greater than the threshold distance (Xth).

Alternatively, the threshold distance may be determined in accordance with the size of the outline of the first stroke. For example, the size of the outline of the first stroke may be the size of the circumscribed rectangle of the first stroke. In this case, the threshold distance may be determined in accordance with the width or the height of the rectangle. The width of the rectangle is the lateral (x-directional) dimension of the rectangle. The height of the rectangle is the longitudinal (y-directional) dimension of the rectangle. For example, the threshold distance may be several times the lateral (x-directional) dimension of the rectangle or may be determined on the basis of the longitudinal (y-directional) dimension of the rectangle.

The threshold distance may be determined on the basis of the relationship between the size of the screen (page) and the size of the outline of the first stroke. For example, the distance which is substantially half the lateral (x-directional) dimension of the page may be set as the default threshold distance. The default threshold distance may be increased or decreased in accordance with the size of the outline of the first stroke.

When the first stroke is one of a plurality of strokes constituting one handwritten character, the threshold distance may be determined in accordance with the size of the outline of the handwritten character.

Further, as the threshold distance, two threshold distances may be used: that (Xth) related to the lateral distance between the first and second areas, and that (Yth) related to the longitudinal distance between those two areas. In this case, the lateral distance between the first and second areas is compared with the lateral threshold distance (Xth), and the longitudinal distance between the first and second areas is compared with the longitudinal threshold distance (Yth). The handwriting-complete processing module 308 is capable of determining whether or not the second stroke is handwritten in a line different from the line in which the first stroke is handwritten by using the longitudinal threshold distance (Yth).

For threshold distance Yth, a value less than threshold distance Xth may be used. In this case, the handwriting-complete processing module 308 determines that the first stroke is separate from the second stroke when the lateral distance between the first and second strokes is greater than threshold distance Xth, or when the longitudinal distance between the first and second strokes is greater than threshold distance Yth, which is less than threshold distance Xth. In other words, the handwriting-complete processing module 308 determines that the first stroke is separate from the second stroke when the longitudinal distance between the first and second strokes is greater than threshold distance Yth, even in a case where the lateral distance between the first and second strokes is less than or equal to threshold distance Xth. When the handwriting-complete processing module 308 determines that the first stroke is separate from the second stroke, the handwriting-complete processing module 308 obtains, from the stroke candidate database 402B, some stroke strings (stroke candidates) corresponding to the second stroke regardless of the first stroke, and displays these stroke candidates in the list of stroke candidates 501 on the edit screen 600.

Threshold distance Xth may be determined using at least one of the size of the screen (page) (for example, the lateral dimension of the page) and the size of the outline of the first stroke (in other words, the lateral or longitudinal dimension of the circumscribed rectangle of the first stroke). A distance less than determined threshold distance Xth may be determined as threshold distance Yth.

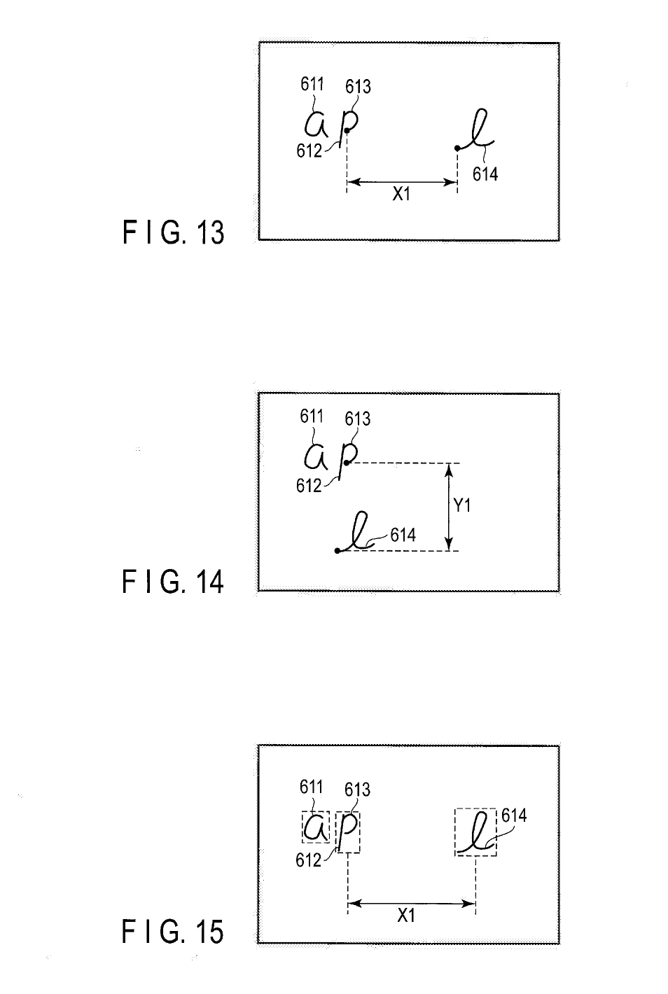

FIG. 13 shows an example of an operation for calculating the lateral distance between two strokes.

In a state similar to that of FIG. 11, here, it is assumed that stroke 614 corresponding to the handwritten character “l” is input by handwriting after strokes 611, 612 and 613 corresponding to the handwritten character string “ap” are input by handwriting. The lateral distance X1 between strokes 613 and 614 is obtained by calculating the difference between the coordinates of the end point of the last stroke of the handwritten character string “ap” and the coordinates of the start point of the handwritten character “l”. Specifically, distance X1 is the absolute value of the difference between the x-coordinate of the end point of stroke 613 and the x-coordinate of the start point of stroke 614.

FIG. 14 shows an example of an operation for calculating the longitudinal distance between two strokes.

The longitudinal distance Y1 between strokes 613 and 614 is obtained by calculating the distance between the coordinates of the end point of the last stroke of the handwritten character string “ap” and the coordinates of the start point of the handwritten character “l”. Specifically, distance Y1 is the absolute value of the difference between the y-coordinate of the end point of stroke 613 and the y-coordinate of the start point of stroke 614.

FIG. 15 shows another example of an operation for calculating the lateral distance between two strokes.

Stroke 613 is one of the two strokes constituting the handwritten character “p”. In this case, the absolute value of the difference between the x-coordinate of the center of the circumscribed rectangle of the handwritten character “p” and the x-coordinate of the center of the circumscribed rectangle of the handwritten character “l” may be calculated as the lateral distance X1 between strokes 613 and 614.

Further, the above threshold distance (Xth) may be determined on the basis of the x-directional dimension of the circumscribed rectangle of the handwritten character “p”.

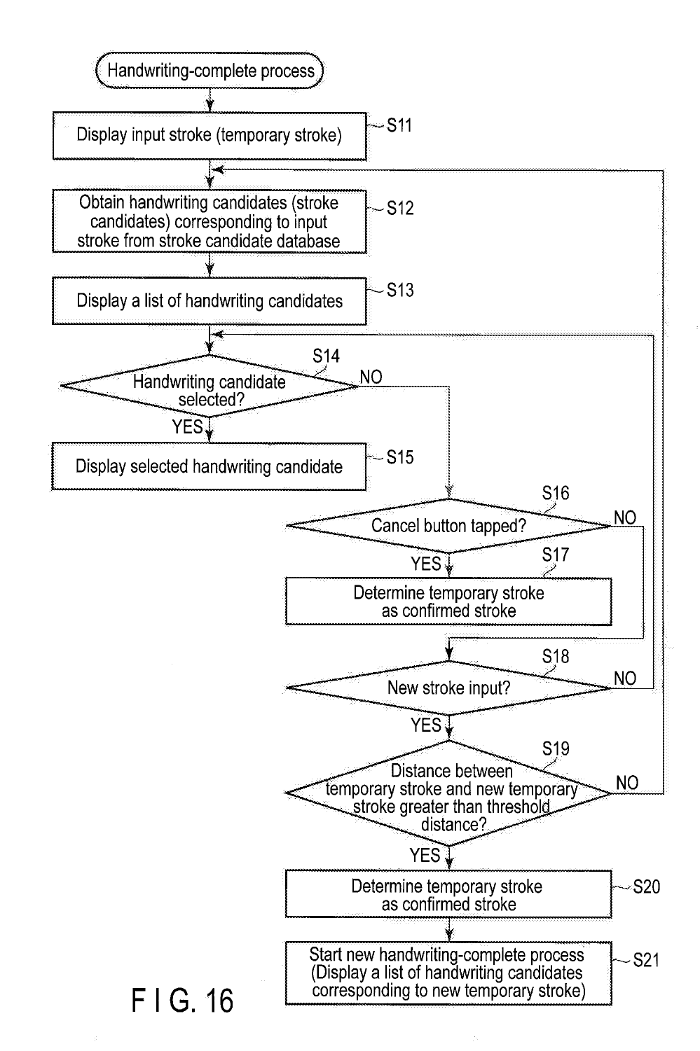

The flowchart of FIG. 16 shows the procedure of the handwriting-complete process described above.

When a stroke is input through the user's handwriting input operation, the pen locus display processing module 301 receives the input stroke (temporary stroke) made on a first position of the screen and displays the input stroke (temporary stroke) at the first position on the screen (step S11). The handwriting-complete processing module 308 receives stroke data corresponding to the input stroke from the time-series data generation module 302.

The handwriting-complete processing module 308 obtains a stroke string (stroke candidate) corresponding to the input stroke from the stroke candidate database 402B (step S12) based on the input stroke. In other word, the handwriting-complete processing module 308 determines the stroke string (stroke candidate) in accordance with the input stroke.

The process of step S12 is equivalent to a process for predicting the handwritten stroke string (handwritten character string) likely to be input by the user on the basis of the input stroke (temporary stroke) and the stroke candidate database 402B. The handwriting-complete processing module 308 performs a process for displaying a list of stroke candidates (handwriting candidates), in other words, the list of stroke candidates 501, on the screen (step S13). Some stroke candidates (handwriting candidates) are displayed in the list of stroke candidates 501.

The handwriting-complete processing module 308 determines whether or not the user selects a handwriting candidate (stroke string) (step S14). When the user selects a stroke candidate (stroke string) (YES in step S14), the handwriting-complete processing module 308 displays the selected stroke candidate on the screen in cooperation with the display processing module (step S15). In step S15, the display processing module displays the selected stroke candidate in place of the input stroke (temporary stroke). The input stroke (temporary stroke) is replaced by the selected stroke candidate. The selected stroke candidate is determined as a confirmed stroke and is reflected in the handwritten page which is in the process of being created or edited.

When the user, instead of selecting a stroke candidate (stroke string), taps the cancel button 502 (YES in step S16), the handwriting-complete processing module 308 determines the input stroke (temporary stroke) as a confirmed stroke string (step S17). In step S17, the handwriting-complete processing module 308 deletes the list of stroke candidates 501 from the screen.

When the user neither selects a stroke candidate (stroke string) nor taps the cancel button 520, but instead inputs a stroke (new temporary stroke) by handwriting (YES in step S18), the pen locus display processing module 301 receives the new input stroke (new temporary stroke) made on a second position of the screen and displays the new input stroke (new temporary stroke) at the second position on the screen. The handwriting-complete processing module 308 proceeds to step S19. In step S19, the handwriting-complete processing module 308 calculates the distance between the temporary stroke and the new temporary stroke. The handwriting-complete processing module 308 determines whether or not the distance between the temporary stroke (the first position) and the new temporary stroke (the second position) is greater than a threshold distance.

When the distance between the temporary stroke and the new temporary stroke is greater than the threshold distance (YES in step S19), the handwriting-complete processing module 308 determines the temporary stroke as a confirmed stroke (step S20). In step S20, the temporary stroke is determined to enter and is reflected in the handwritten page. The handwriting-complete processing module 308 starts a new handwriting-complete process for the new temporary stroke (step S21). In step S21, the handwriting-complete processing module 308 obtains a stroke string (stroke candidate) corresponding to the new temporary stroke from the stroke candidate database 402B based on the new temporary stroke. The stroke candidate is a handwriting candidate conforming to only the new temporary stroke. The handwriting-complete processing module 308 displays a list of stroke candidates (handwriting candidates) on the screen.

When the distance between the temporary stroke and the new temporary stroke is not greater than the threshold distance (NO in step S19), the handwriting-complete processing module 308 proceeds to step S12. In step S12, the handwriting-complete processing module 308 obtains, from the stroke candidate database 402B, a stroke string (stroke candidate) corresponding to the stroke string including the temporary stroke and the new temporary stroke, based on a combination of the temporary stroke and the new temporary stroke. The stroke candidate is a handwriting candidate conforming to both the temporary stroke and the new temporary stroke. The handwriting-complete processing module 308 displays a list of stroke candidates (handwriting candidates) on the screen (step S13).

As explained above, in the present embodiment, when a stroke (the first stroke) made on a first position of the screen is received, the first stroke is displayed at the first position on the screen, and a first handwriting candidate conforming to the first stroke is determined in accordance with the first stroke. The first handwriting is displayed on the screen. When the second stroke made on a second position of the screen is received, the second stroke is displayed at the second position on the screen, and a distance between the first position and the second position is determined. Then, in accordance with the distance, a second handwriting candidate conforming to both the first stroke and the second stroke, or a third handwriting candidate conforming to the second stroke, not the first stroke, is determined, and either the second handwriting candidate or the third handwriting candidate is displayed on the screen.

That is, whether the second handwriting candidate or the third handwriting candidate should be displayed is automatically determined in accordance with the distance between the first and second positions.

When the second stroke is written near the first stroke, the second handwriting candidate conforming to both the first and second strokes is shown to the user as stroke candidates. When the second stroke is written away from the first stroke, the third handwriting candidate conforming to the second stroke, not the first stroke, is shown to the user as stroke candidates.

Thus, the user can easily change the base stroke for displaying handwriting candidate without performing a special operation such as tapping the cancel button 502 during the handwriting input operation. In this manner, it is possible to realize a smooth handwriting input operation.

Each process of the present embodiment can be realized by a computer program. Therefore, an effect similar to that of the present embodiment can be easily realized by merely installing the computer program on a computer through a computer-readable storage medium in which the computer program is stored and executing the computer program.

The CPU of the computer on which the computer program is installed can function as a hardware processor configured to perform the above handwriting-complete process. The GPU of the computer can function as a display processor configured to display each stroke on the screen.

In the present embodiment, it is assumed that a tablet computer is used. However, the function for processing a handwritten document in the present embodiment may be also applied to a normal desktop computer. In this case, for example, a tablet which is the input device for handwriting input may be connected to the desktop computer.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a display configured to detect a stroke made on a screen of the display and display the stroke on the screen; and
a hardware processor configured to:
receive a first stroke made on a first position of the screen;
display the first stroke at the first position on the screen;
determine a first handwriting candidate in accordance with the first stroke;
display the first handwriting candidate on the screen;
receive a second stroke made on a second position of the screen;
display the second stroke at the second position on the screen;
determine a distance between the first position and the second position;
determine, in accordance with the distance, either a second handwriting candidate conforming to both the first stroke and the second stroke or a third handwriting candidate conforming to the second stroke, not the first stroke; and
display either the second handwriting candidate or the third handwriting candidate on the screen.

2. The electronic device of claim 1, wherein the hardware processor is further configured to display on the screen the third handwriting candidates if the distance is greater than a first distance, and display on the screen the second handwriting candidates if the distance is not greater than the first distance.

3. The electronic device of claim 1, wherein
the hardware processor is further configured to display on the screen the third handwriting candidates if a lateral distance between the first and second positions is greater than a first distance or if a longitudinal distance between the first and second positions is greater than a second distance less than the first distance.

4. The electronic device of claim 2, wherein
the first distance is determined in accordance with at least one of a size of the screen and a size of outline of the first stroke.

5. The electronic device of claim 1, wherein
each of the first handwriting candidate, the second handwriting candidate and the third handwriting candidate includes at least one stroke.

6. A method comprising:
receiving a first stroke made on a first position of a screen of a display;
displaying the first stroke at the first position on the screen;
determining a first handwriting candidate in accordance with the first stroke;
displaying the first handwriting candidate on the screen;
receiving a second stroke made on a second position of the screen;
displaying the second stroke at the second position on the screen;
determining a distance between the first position and the second position;
determining, in accordance with the distance, either a second handwriting candidate conforming to both the first stroke and the second stroke or a third handwriting candidate conforming to the second stroke, not the first stroke; and
displaying either the second handwriting candidate or the third handwriting candidate on the screen.

7. The method of claim 6, wherein
the third handwriting candidate is displayed on the screen if the distance is greater than a first distance, and the second third handwriting candidate is displayed on the screen if the distance is not greater than the first distance.

8. The method of claim 6, wherein
the third handwriting candidate is displayed on the screen if a lateral distance between the first and second positions is greater than a first distance or if a longitudinal distance between the first and second positions is greater than a second distance less than the first distance.

9. The method of claim 7, wherein
the first distance is determined in accordance with at least one of a size of the screen and a size of outline of the first stroke.

10. The method of claim 6, wherein
each of the first handwriting candidate, the second handwriting candidate and the third handwriting candidate includes at least one stroke.
